(19) United States
(12) Patent Application Publication
(10) Pub. No.: US 2023/0028599 A1
(43) Pub. Date: Jan. 26, 2023

(54) POWER SUPPLIES

(71) Applicant: HEWLETT-PACKARD DEVELOPMENT COMPANY, L.P., Spring, TX (US)

(72) Inventor: Chao-Wen Cheng, Taipei City (TW)

(73) Assignee: HEWLETT-PACKARD DEVELOPMENT COMPANY, L.P., Spring, TX (US)

(21) Appl. No.: 17/787,825

(22) PCT Filed: Dec. 20, 2019
(86) PCT No.: PCT/US2019/067876

§ 371 Date: Jun. 21, 2022

(51) Int. Cl. H02M 1/42; H02M 1/12

(52) U.S. Cl. CPC H02M 1/4208; H02M 1/12

(57) ABSTRACT

Structures and functions of power supplies are disclosed. In an example, a power supply includes a power factor correction circuit and a bypass circuit. The bypass circuit bypasses the power factor correction circuit when the switch of the bypass circuit is on in response to a predetermined range of input power of the power supply. The bypass circuit also includes a delay circuit to delay the activation of the bypass circuits in response to the predetermined range of input power of the power supply for a predetermined time period.

### BACKGROUND

A power supply is a part of all types of electronic devices and electrical systems. The power supply provides power to a device by converting received electrical power in another form of electric power that is compatible with the device. The most common conversions are alternating current (AC) to direct current (DC), DC to AC, DC to DC and AC to AC conversion.

An AC to DC power supply is used in devices including laptops, tablets, mobiles, and digital cameras. For the better and long-lasting performance of the devices, the power supply needs to be as efficient as possible.

### BRIEF DESCRIPTION OF THE DRAWINGS

Some examples of the present application are described with respect to the following figures:

FIG. 1 illustrates a power supply, according to an example.

FIG. 2 illustrates a detailed view of a bypass and a PFC circuit of a power supply, according to an example.

FIG. 3 illustrates the architecture of a bypass circuit of a power supply, according to an example.

FIG. 4 illustrates a flow chart of the method of operation of a power supply, according to an example.

FIG. 5 illustrates a flow chart of an operation of a power supply, according to an example.

FIG. 6 illustrates a flow chart of an operation of a power supply, according to an example

### DETAILED DESCRIPTION

Electrical and electronic devices including laptop computers, notebook computers or other types of computing devices have a power supply to fulfill the power requirements of the devices. A power supply of a laptop, for example, may convert the AC power received from a power outlet into a power adequate for the device i.e. DC power for most of the devices. Examples described herein an efficient power supply for an electronic device.

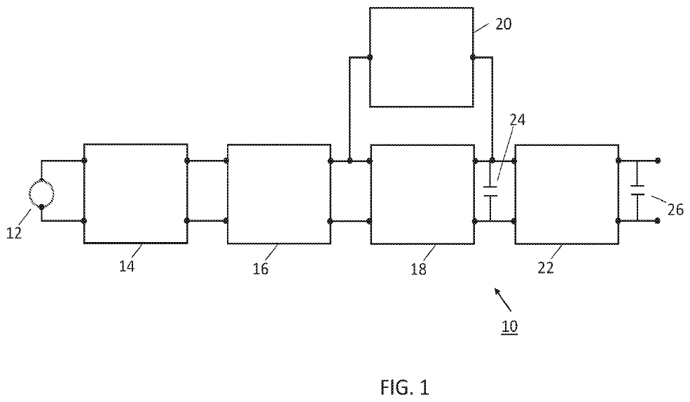

FIG. 1 illustrates a power supply 10 receives AC power from AC power source 12 and converts the AC power into DC power and the output DC power across an output capacitor 26. The power supply 10 includes a filter 14, a rectifier 16, a power factor correction (PFC) circuit 18, a bypass circuit 20 and an isolator 22. The filter 14 suppresses the electronic noise present in the input power received from the AC power source 12. The rectifier 16 converts the bipolar input AC power into unipolar power. The rectifier 16 can be a full-wave, a half-wave rectifier or any other type of rectifier circuit known in the state of the art. The isolator 22 isolates the power supply 10 from a subsequent circuit i.e. load, not shown in figures, to isolate and protect the load against voltage or current fluctuations in the power supply 10. In an example, the isolator 22 is a PWM circuit. In another example, the isolator is a power convertor.

The PFC circuit 18 and the bypass circuit 20 are connected in parallel, as illustrated in FIG. 1, and are functional one at a time depending upon the power available at the output of the rectifier 16. If the output power of the rectifier 16 is not in a predetermined range than the PFC circuit 18 turns on and the bypass circuit remains off. In an example, the predetermined range is zero to 75 watts. In another example, the predetermined range is any power less than a lower power limit of the power supply 10. Under on condition, the PFC circuit 18 measures the current and voltage of the unipolar power received from the rectifier 16 and adjusts the phase switching time and duty cycle to ensure the current and voltage of the input power are in phase. The PFC circuit 18 supplies the adjusted power to the isolator 22 through a bulk capacitor 24.

If the output power of the rectifier 16 is within the predetermined range for a predetermined time period than the PFC circuit 18 turns off and the bypass circuit 20 turns on. When turns on, the bypass circuit 20 bypasses the PFC circuit 18 and transfer the output power of the rectifier 16 directly at the input port of the isolator 22. In an example, the predetermined range of the power to turn on the bypass circuit 20 is zero to 75 watts. In another example, the predetermined range is any power less than a lower power limit of the power supply 10. If the output power of the rectifier 16 is not in range of zero to 75 watts then the PFC circuit 18 will remain on and the bypass circuit 20 will remain off.

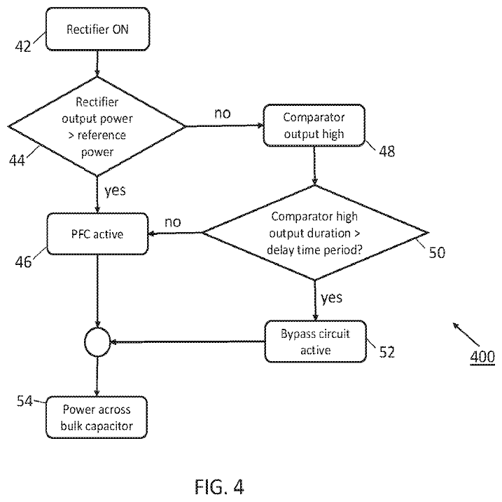

In some examples, functionalities described herein in relation to any of FIGS. 1-3 may be provided in combination with functionalities described herein in relation to any of FIGS. 4-6.

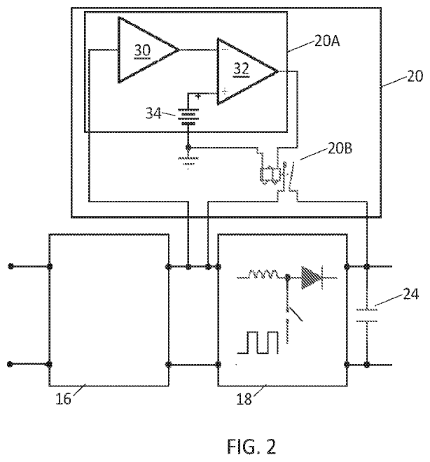

FIG. 2 illustrates a detailed view of the bypass circuit 20 of the power supply 10, shown in FIG. 1. The bypass circuit 20 is connected in parallel with the PFC circuit 18, as explained in FIG. 1. The bypass circuit 20 and the PFC circuit 18 receives input power from the rectifier 16. The PFC circuit 18 is a power correction circuit that includes a coil, a diode and a switch, as known in the state of the art.

The bypass circuit 20 includes a monitor circuit 20A and a switch 20B. The monitor circuit 20A monitors the output of the rectifier 16. In an example, the monitor circuit 20A includes a buffer 30, a comparator 32 and a reference power 34. The output power of the rectifier 16 supplied to a negative input port of the comparator 32 through the buffer 30. If the rectifier 16 output power is higher than the power supplied by the reference power 34 to a positive input port of the comparator 32 then the output of the comparator 32 remains low which in turn keeps the switch 20B in an off state. When the switch 20B is off then the bypass circuit 20 is inactive and the PFC 18 is active. On the other hand, if the rectifier 16 output power, supplied to the negative input port of the comparator 32, is less than the power supplied by the reference power 34 to the positive input port of the comparator 32 then the output of the comparator 32 goes high which turns the switch 20B on. When the switch 20B is on then the bypass circuit 20 is active and as a result, it connects the output terminal of the rectifier 16 with the bulk capacitor 24. When the switch 20B is on, a direct connection forms between the rectifier 16 output and the bulk capacitor 24, which bypasses the PFC 18 and subsequently enhances the efficiency of the power supply 10 by avoiding the use of PFC 18 when the output power of the rectifier 16 is within the predetermined range. In an example, the monitor circuit 20A is a microcontroller-based circuit which includes an analog to digital converter and a timer function.

On and off state of the switch 20B depends upon the comparison of the rectifier 16 output power and the power supplied by the reference power 34. The predetermined range of power at which the bypass circuit 20 switches from off to on state should be the power of the reference power 34 supplied to the comparator 32. In an example, for the efficient operation of the power supply 10, the PFC circuit should bypass for lower power inputs to the power supply 10. In an example, the lower input range of the power supply 10 or the predetermined range of power is less than 75 watts.

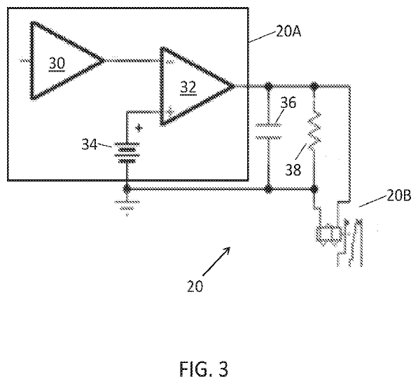

FIG. 3 illustrates an architecture of a bypass circuit 20 of the power supply 10, shown in FIG. 1, according to the example. The bypass circuit 20 in FIG. 3 includes a capacitor 36 and a resistor 38 along with the monitor circuit 20A and the switch 20B. The monitor circuit 20A monitors the output of the rectifier 16 and sets the output of the comparator 32 high if the output power of the rectifier 16 is less than the power supplied by the reference power 34, as explained in FIG. 2. The capacitor 36 starts charging when the output of the comparator 32 is high and switch on the switch 20B once the capacitor 36 is fully charged. When the comparator 32 is low then the capacitor 36 discharges through the resistor 38. In other words, to turn on the switch 20B the output of the comparator 32 should remain high at least for the time period in which the capacitor 36 charges completely. The capacitor 36 and resistor 38 introduce a delay to avoid frequent switching of the switch 20B.

FIG. 4 illustrates a flow chart of the method of operation of the power supply 10, according to the example. The method 400 of operation generally includes monitoring input power of the power supply by a monitor circuit, turning on a bypass circuit to bypass a power factor correction circuit if the input power is less than a predetermined value for a predetermined time period, and turning on the power factor correction circuit to bypass the bypass circuit if the input power is more than a predetermined value for a predetermined time period. The method 400 may be implemented by the circuitry of an electronic device, such as power supply system of FIG. 1.

At block 42 of the flow chart, the rectifier 16 is active and producing an output power. The rectifier 16 receives the bipolar input AC power from filter 14 and converts into unipolar power as the output power, as shown in FIG. 1.

At block 44, the rectifier 16 output power and the power produced by the reference power 34 is compared by the comparator 32 of the monitor circuit 20A. If the output power of the rectifier 16 is greater than the power produced by the reference power 34 then the PFC circuit 18 turns on and the bypass circuit 20 turns off. If the output power of the rectifier 16 is less than the power produced by the reference power 34 then the PFC circuit 18 remains off and the bypass circuit 20 turns on.

At block 46, the PFC circuit 18 is in on state. At block 44, if the output power of the rectifier 16 is greater than the power produced by the reference power 34 the output of the comparator 32 of the monitor circuit 20A remains low which keeps the bypass circuit 20 in the off state. Due to off state of the bypass circuit 20, the PFC circuit 18 remains in on state, as explained in previous figures.

At block 48, the output of the comparator 32 of the monitor circuit 20A switches to a high state from a low state. At block 44, if the output power of the rectifier 16 is less than the power produced by the reference power 34 then the output of the comparator 32 switches to a high state, as explained in previous figures.

At block 50, a condition is evaluated i.e. the time period for which the output of the comparator 32 remains at high state is sufficient to charge the capacitor 36 at a maximum level, as explained in FIG. 3. In an example, the time taken by the capacitor 36 to charge up to a maximum limit is the predetermined time period. If the time period for which the output of the comparator 32 of the monitor circuit 20A remains high is less than the predetermined time period i.e. the time to charge the capacitor 36 at the maximum level then the bypass circuit 20 remains in off state and the PFC circuit 18 remains in on state, at block 46.

At block 52, if the time period for which the output of the comparator 32 remains at high state is sufficient to charge the capacitor 36 at a maximum level then the switch 20B of the bypass circuit 20 turns on and a direct connection establishes between the output of the rectifier 16 and the bulk capacitor 24, as shown in FIG. 2. The direct connection between the output of the rectifier 16 and the bulk capacitor 24 bypasses the PFC circuit 18 which means the connection between the output of the rectifier 16 and the bulk capacitor 24 deactivates the PFC circuit 18.

At block 54, power applies across the bulk capacitor 24 either by the PFC circuit 18 or by the bypass circuit 20 depending upon the output power of the rectifier 16. If the rectifier 16 output is less than the predetermined power for the predetermined time period, then the bulk capacitor receives power from the bypass circuit 20. If the rectifier 16 output is more than the predetermined power, then the bulk capacitor receives power from the PFC circuit 18. Also, if the rectifier 16 output is less than the predetermined power for the time period less than the predetermined time period then the bulk capacitor receives power from the PFC circuit 18.

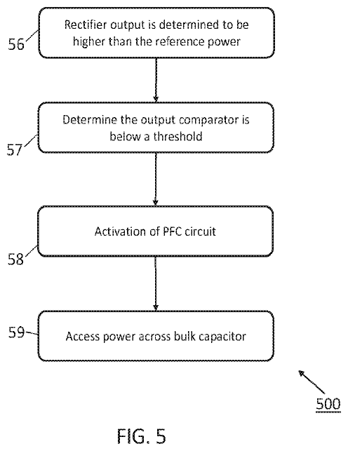

FIG. 5 illustrates a flow chart of an operation of a power supply 10 when the PFC circuit 18 s active and the bypass circuit 20 is inactive, according to an example. The method 500 of operation generally includes the input power to a bypass circuit and a power factor correction circuit is higher than a predetermined value which deactivates the bypass circuit by turning off a comparator of the bypass circuit. The higher input power turns on the power factor correction circuit and the output of the power factor correction circuit appears across a bulk capacitor. The method 500 may be implemented by the circuitry of an electronic device, such as the power supply system of FIG. 2.

At block 56 of the flow chart, illustrated in FIG. 5, the output power of the rectifier 16 is higher than the power of the reference power 34 which is connected to a positive terminal of the comparator 32 of the monitor circuit 20A of the bypass circuit 20, as shown in FIG. 2. The output of the rectifier 16 is connected to a negative terminal of the comparator 32 of the monitor circuit 20A through the buffer 30, as shown in FIG. 2.

At block 57, the comparator 32 output remains low. At block 56, the output power of the rectifier 16 is higher than the power of the reference power 34. The condition at block 56 implies the power at the negative terminal of the comparator 32 is higher than the power at the positive terminal of the comparator 32, as shown in FIG. 2, hence the output of the comparator 32 remains low.

At block 58, the PFC circuit 18 remains active as the switch 20B of the bypass circuit 20 remains off as the output of the comparator 32 is low. The output of the PFC circuit 18 applies across the bulk capacitor 24, as shown in FIG. 2, at block 59, as the PFC circuit 18 is active and the switch 20B of the bypass circuit 20 is off.

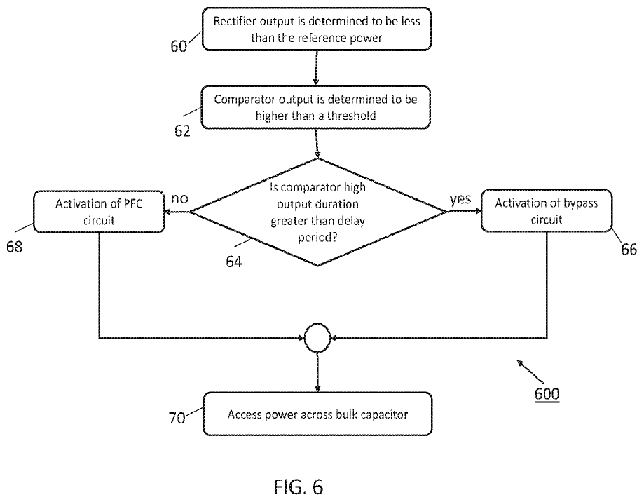

FIG. 6 illustrates a flow chart of the power supply 10 as an example. The method 600 of operation generally includes the input power to a bypass circuit and a power factor correction circuit is less than a predetermined value for a predetermined time period which activates the bypass circuit by turning on a comparator of the bypass circuit and if the input power to a bypass circuit and a power factor correction circuit is higher than a predetermined value for a time period less than the predetermined time period then the power correction circuit turns on and the bypass circuit turns on. The method 400 may be implemented by the circuitry of an electronic device, such as the power supply system of FIG. 2.

At block 60 of the flow chart, illustrated in FIG. 6, the output power of the rectifier 16 is less than the power of the reference power 34 which is connected to a positive terminal of the comparator 32 of the monitor circuit 20A of the bypass circuit 20, as shown in FIG. 2. The output of the rectifier 16 is connected to a negative terminal of the comparator 32 of the monitor circuit 20A through the buffer 30, as shown in FIG. 2.

At block 62, the output of the comparator 32 of the monitor circuit 20A switches to a high state from a low state. At block 60, the output power of the rectifier 16 is less than the power of the reference power 34. Due to less rectifier 16 output power, the power at the negative terminal of the comparator 32 is less than the power at the positive terminal of the comparator 32 hence the comparator 32 output switches to a high state, as explained in previous figures.

Block 64 illustrates an evaluation of a condition i.e. the time period for which the output of the comparator 32 remains at high state is sufficient to charge the capacitor 36 at a maximum level, as shown in FIG. 3. In an example, the time taken by the capacitor 36 to charge up to a maximum limit is the predetermined time period for which the output of the comparator 32 remains high in order to turn the switch 20B on. If the time period for which the output of the comparator 32 of the monitor circuit 20A remains high is less than the predetermined time period i.e. the time to charge the capacitor 36 at the maximum level, then the bypass circuit 20 remains in off state and the PFC circuit 18 remains in on state. At block 66, if the output of the comparator 32 of the monitor circuit 20A remains high for the time period in which the capacitor 36 charges to a maximum limit, the switch 20B of the bypass circuit 20 turns on which activates the bypass circuit 20.

At block 68, if the output of the comparator 32 of the monitor circuit 20A remains high for the time period less than the time in which the capacitor 36 charges to a maximum limit, the switch 20B of the bypass circuit 20 remains off which keeps the bypass circuit 20 inactive. Due to inactive bypass circuit 20, the output of the rectifier 16 connects with the bulk capacitor 24 through the PFC circuit 20, as shown in FIG. 2. Due to duration for which the comparator 32 output remains high is less than the time period in which the capacitor 36 charges to the maximum limit, the PFC circuit remains on, at block 68 of the flow chart illustrated in FIG. 6.

At block 70, the bulk capacitor 24 receives power from the output of the rectifier 16 either through the PFC circuit 18 or through a direct connection stablishes due to activation of the bypass circuit 20, as shown in FIG. 2. When the rectifier 16 output power is less than the power of the reference power 34 for the duration more than a predetermined time period then the bulk capacitor 24 receives power through the direct connection stablishes due to the activation of the bypass circuit 20. In the other scenarios, when the rectifier 16 output power is less than the power of the reference power 34 for the duration less than the predetermined time period then the bulk capacitor 24 receives output power of the rectifier 16 through the PFC circuit 18, as shown in FIG. 2.

Although the flow diagrams of FIGS. 4-6 illustrate specific orders of execution, the execution order may differ from that which is illustrated. For example, the execution order of the blocks may be scrambled relative to the order shown. Also, the blocks shown in succession may be executed concurrently or with partial concurrence. All such variations are within the scope of the present description.

All the features disclosed in this specification (including any accompanying claims, abstract and drawings), and/or all the elements of any method or process so disclosed, may be combined in any combination, except combinations where at least some of such features and/or elements are mutually exclusive.

The terms “include,” “have,” and variations thereof, as used herein, mean the same as the term “comprise” or appropriate variation thereof. Furthermore, the term “based on,” as used herein, means “based at least in part on.” Thus, a feature described as based on some stimulus may be based only on the stimulus or a combination of stimuli including the stimulus. The article “a” as used herein does not limit the element to a single element and may represent multiples of that element. Furthermore, use of the words “first,” “second,” or related terms in the claims are not used to limit the claim elements to an order or location, but are merely used to distinguish separate claim elements.

The present description has been shown and described with reference to the foregoing examples. It is understood that other forms, details, and examples may be made without departing from the spirit and scope of the following claims.

What is claimed is:

1. A power supply, comprising:
a power factor correction circuit; and
a bypass circuit to bypass the power factor correction circuit, wherein the bypass circuit includes:
a switch to activate the bypass circuit in response to a predetermined range of input power of the power supply; and
a delay circuit to delay the activation of the bypass circuits in response to the predetermined range of input power of the power supply for a predetermined time period.

2. The power supply of claim 1, further comprising:
a filter circuit to suppress the electronic noise of the input power of the power supply;
a rectifier circuit coupled at the input of the bypass circuit and coupled at the input of the power factor correction circuit, the rectifier circuit to convert the input power of the power supply from bipolar to unipolar; and
an isolator circuit coupled at the output of the bypass circuit and coupled at the output of the power factor correction circuit, the isolator circuit to isolate the power supply from a circuit subsequent to the power supply.

3. The power supply of claim 1, wherein the bypass circuit is connected in parallel with the power factor correction circuit.

4. The power supply according to claim 1, wherein the bypass circuit comprises a pin monitor circuit to monitor the input power of the power supply.

5. The power supply according to claim 1, wherein the delay circuit of the bypass circuit includes a resistive element and a capacitive element connected in parallel.

6. The power supply according to claim 1, wherein the bypass circuit is activated when the input power of the power supply is within the predetermined range for the predetermined time period.

7. The power supply according to claim 1, wherein the power factor correction circuit is activated when the input power of the power supply is within the predetermined range for the predetermined time period.

8. The power supply according to claim 1, wherein the power factor correction circuit is activated when the input power of the power supply is outside the predetermined range for the predetermined time period.

9. The power supply according to claim 1, wherein the bypass circuit is activated when the input power of the power supply is outside the predetermined range for the predetermined time period.

10. The power supply of claim 1, wherein the predetermined range of input power of the power supply is about zero to about 75 watts.

11. A method for operating power supply, comprising:
monitoring input power of the power supply by a pin monitor circuit;
activating a bypass circuit to bypass a power factor correction circuit if the input power is less than a predetermined value for a predetermined time period; and
activating the power factor correction circuit to bypass the bypass circuit if the input power is more than a predetermined value for a predetermined time period.

12. The method as defined in claim 11, wherein the predetermined value of the input power of the power supply is about 75 watts.

13. The method as defined in claim 11, further comprising
filtering high-frequency electronic noise of the input power;
converting the input power from bipolar to unipolar;
activating the power factor correction circuit if the input power is less than the predetermined value for the predetermined time period; and
activating the bypass circuit if the input power is more than the predetermined value for the predetermined time period.
